(19) United States
(12) Patent Application Publication
(10) Pub. No.: US 2018/0160850 A1
(43) Pub. Date: Jun. 14, 2018

(54) BARBECUE CLEANING KIT

(71) Applicant: Christopher J. Putnam, Artesia, CA (US)

(72) Inventor: Christopher J. Putnam, Artesia, CA (US)

(21) Appl. No.: 15/376,915

(22) Filed: Dec. 13, 2016

(51) Int. Cl. A47J 37/07; B08B 1/00; A47L 17/00

(52) U.S. Cl. CPC A47J 37/0786; A47L 17/00; B08B 1/005

(57) ABSTRACT

A barbecue cleaning kit is provided to remove soot and grease from a barbecue apparatus. The barbecue cleaning kit includes: (i) a barbecue scraper, (ii) a barbecue scoop, and (iii) a plastic disposable bag. The barbecue scraper is adapted to scrape the soot and grease. The barbecue scraper includes: (i) a first handle, (ii) a thumb stop, and (iii) a blade. The first handle allows the user to hold the barbecue scraper. The thumb stop allows the user to maintain a grip to hold the barbecue scraper. The blade scrapes the soot and grease. The barbecue scoop collects the soot and grease. The barbecue scoop includes: (i) a second handle, and (ii) a scoop pan. The second handle allows the user to hold the barbecue scoop. The scoop pan collects the soot and grease. The plastic disposable bag collects the soot and grease. The plastic disposable bag includes a rough edge that scrapes the soot and grease off the barbecue scraper and the barbecue scoop.

### BACKGROUND

### Technical Field

The embodiments herein generally relate to a cleaning kit and more particularly, a barbecue cleaning kit.

### Description of the Related Art

Outdoor cooking has always been a popular activity during outdoor visits with friends or family. The outdoor cooking activities include boiling, grilling and/or flying. Barbecue in grilling is the favorite cooking activity among most of the people. Cooking in barbecue apparatus may generate the pollutants like soot and grease. The soot and grease catches fire very rapidly and leads to the flame generation. The soot and grease increases with time during barbequing. The soot and grease needs to be removed from time to time to avoid flame generation. Some tools are available in the market, like wire-brushes, to remove the upper part of the barbecue apparatus. But such tools are expensive and inefficient to clean under the barbecue grill, drip pan and drip bucket properly. Already available tools are inefficient in cleaning the barbecue apparatus of different shapes.

Accordingly, there remains a need of a safe, cheap and efficient cleaning kit to remove the soot and grease from the barbecue apparatus.

### SUMMARY

In view of the foregoing, an embodiment herein provides a barbecue cleaning kit for removing soot and grease from a barbecue apparatus. The barbecue cleaning kit includes: (i) a barbecue scraper, (ii) a barbecue scoop, and (iii) a disposable bag. The barbecue scraper is adapted to scrape the soot and grease. The barbecue scraper includes: (i) a first handle, (ii) a thumb stop, and (iii) a blade. The first handle is adapted to allow a user to hold the barbecue scraper. The thumb stop is adapted to allow the user to maintain a grip to hold the barbecue scraper. The blade is adapted to scrape the soot and grease. The barbecue scoop is adapted to collect the soot and grease. The barbecue scoop includes: (i) a second handle, and (ii) a scoop pan. The second handle is adapted to allow the user to hold the barbecue scoop. The scoop pan is adapted to collect the soot and grease. The disposable bag is adapted to collect the soot and grease. The disposable bag includes a rough edge that is adapted to scrape the soot and grease off the barbecue scraper and the barbecue scoop.

In one embodiment, the barbecue apparatus may be a gas barbecue apparatus or a charcoal barbecue apparatus. In one embodiment, the first handle is made from a material selected from a group of plastic, rubber or mixture of plastic and rubber. In another embodiment, the second handle is made from a material selected from a group of plastic, rubber or mixture of plastic and rubber.

In one embodiment, the material of the first handle is hard. In another embodiment, the material of the second handle is hard.

In another aspect, the blade is made from a material selected from a group of aluminium, iron or an alloy and the disposable bag is made of plastic.

In yet another aspect, a barbecue cleaning kit is provided to remove soot and grease from a barbecue apparatus. The barbecue cleaning kit includes: (i) a barbecue scraper, (ii) a barbecue scoop, and (iii) a plastic disposable bag. The barbecue scraper is adapted to scrape the soot and grease. The barbecue scraper includes: (i) a first handle, (ii) a thumb stop, and (iii) a blade. The first handle is adapted to allow the user to hold the barbecue scraper. The first handle is made from plastic, rubber or mixture of plastic and rubber. The thumb stop is adapted to allow the user to maintain a grip to hold the barbecue scraper. The blade is adapted to scrape the soot and grease. The blade is made from aluminium, iron or an alloy. The barbecue scoop is adapted to collect the soot and grease. The barbecue scoop includes: (i) a second handle, and (ii) a scoop pan. The second handle is adapted to allow the user to hold the barbecue scoop. The second handle is made from plastic, rubber or mixture. The scoop pan is adapted to collect the soot and grease. The plastic disposable bag is adapted to collect the soot and grease. The plastic disposable bag includes a rough edge that is adapted to scrape the soot and grease off the barbecue scraper and the barbecue scoop. The material of the first handle is hard. The material of the second handle is hard.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof and the embodiments herein include all such modifications.

### BRIEF DESCRIPTION OF THE DRAWINGS

The embodiments herein will be better understood from the following detailed description with reference to the drawings, in which:

FIG. 1 is a diagrammatic representation of a barbecue scraper of a barbecue cleaning kit to clean a barbecue apparatus according to an embodiment herein;

FIG. 2 illustrates a diagrammatic representation of a barbecue scoop of a barbecue cleaning kit to clean the barbecue apparatus according to an embodiment herein; and

FIG. 3 illustrates a diagrammatic representation of a disposable bag of a barbecue cleaning kit to dispose the soot and grease according to an embodiment herein.

### DETAILED DESCRIPTION OF PREFERRED EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

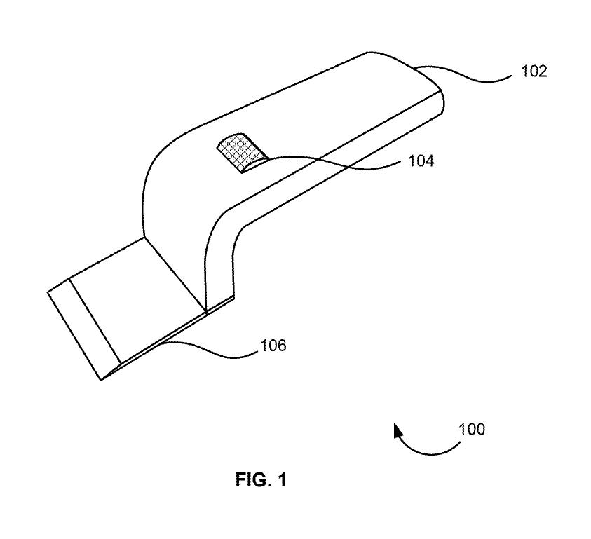

As mentioned, there remains a need of a safe, cheap and an efficient barbecue cleaning kit to remove soot and grease from the bottom of a barbecue apparatus. Referring now to the drawings, and more particularly to FIGS. 1 through 3, where similar reference characters denote corresponding features consistently throughout the figures, there are shown preferred embodiments.

FIG. 1 illustrates a diagrammatic representation of a barbecue scraper 100 of the barbecue cleaning kit to clean the barbecue apparatus according to an embodiment herein. The barbecue scraper 100 includes a first handle 102, a thumb stop 104, and a blade 106. A user holds the barbecue scraper 100 from the first handle 102. The first handle 102 couples a thumb stop 104 for the user to maintain a grip on the barbecue scraper 100. In one embodiment, the first handle 102 is made from a material, including without limiting, plastic, rubber and/or mixture. In another embodiment, the material of the first handle 102 may be hard or soft. The first handle 102 couples a blade 106 with a sharpened edge at the bottom portion for scraping the soot and the grease deposited on the barbecue apparatus due to charcoal or gas used in the barbecue apparatus. In one embodiment, the blade 106 is made from a material including, without limiting, aluminium, stainless steel, iron or an alloy. In another embodiment, the barbecue scraper 100 may be in a shape including, rectangular or round. In another embodiment, the barbecue scraper 100 is used to clean bottom of gas, propane and round barbecue grills.

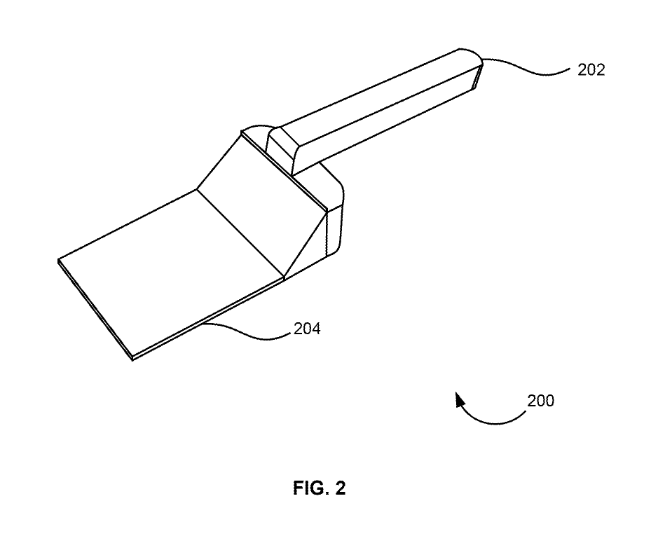

FIG. 2 illustrates a diagrammatic representation of a barbecue scoop 200 of the barbecue cleaning kit to clean the barbecue apparatus according to an embodiment herein. The barbecue scoop 200 includes a second handle 202 and a scoop pan 204. The user holds the barbecue scoop 200 from the second handle 202. In one embodiment, the second handle 202 and the scoop pan 204 are made from a material including without limiting, plastic, rubber and/or mixture thereof. In another embodiment, the material of the second handle 202 may be hard or soft. The second handle 202 couples the scoop pan 204 at the bottom portion of the barbecue scoop 200. The user collects the soot and grease using the scoop pan 204 deposited on the barbecue apparatus due to charcoal or gas used in the barbecue apparatus. In one embodiment, the barbecue scoop 200 removes soot, grease as well as ash.

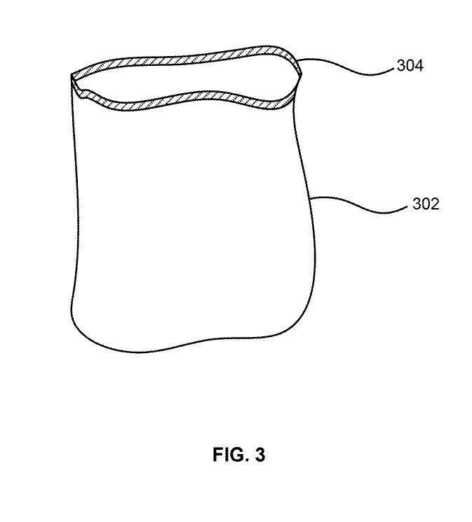

FIG. 3 illustrates a diagrammatic representation of a disposable bag 302 of a barbecue cleaning kit to dispose the soot and grease according to an embodiment herein. The disposable bag 302 collects the soot and grease scraped by the barbecue scraper 100. The disposable bag 302 includes a rough edge 304 at the top of the disposable bag 302. The rough edge 304 scrapes the soot and grease off the barbecue scraper 100 and the barbecue scoop 200. In one embodiment, the disposable bag is made of plastic.

The barbecue cleaning kit greatly cleanses both the outer and the inner sides of the barbecue apparatus. In addition, the barbecue cleaning kit reduces grease fires which may sometimes spread to adjacent structures. The barbecue cleaning kit avoids the fire that may spread to very large extent originating from the barbecue apparatus. The hard plastic handle increases the durability of the barbecue scraper. The stainless steel blade is corrosion resistant and increases the durability of the barbecue scraper. The barbecue cleaning kit includes one or more disposal bags to dispose the collected soot and grease deposit to keep the nearby environment hygienic. The barbecue cleaning kit is comparatively cheap and easy to handle. The barbecue scraper also removes the dried or burnt food stuck in between the spacing bars on the grill.

The foregoing description of the specific embodiments will so fully reveals the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

What is claimed is:

1. A barbecue cleaning kit for removing soot and grease from a barbecue apparatus, wherein said barbecue cleaning kit comprises:
a barbecue scraper that is adapted to scrape said soot and grease, wherein said barbecue scraper comprises:
a first handle that is adapted to allow a user to hold said barbecue scraper;
a thumb stop that is adapted to allow said user to maintain a grip to hold said barbecue scraper; and
a blade that is adapted to scrape said soot and grease;
a barbecue scoop that is adapted to collect said soot and grease wherein said barbecue scoop comprises:
a second handle that is adapted to allow said user to hold said barbecue scoop; and
a scoop pan that is adapted to collect said soot and grease;
a disposable bag that is adapted to collect said soot and grease, wherein said disposable bag comprises;
a rough edge that is adapted to scrape said soot and grease off said barbecue scraper and said barbecue scoop.

2. The barbecue cleaning kit of claim 1, wherein said barbecue apparatus is a gas barbecue apparatus or a charcoal barbecue apparatus.

3. The barbecue cleaning kit of claim 1, wherein said first handle is made from a material selected from a group of plastic, rubber or mixture of plastic and rubber.

4. The barbecue cleaning kit of claim 1, wherein said second handle is made from a material selected from a group of plastic, rubber or mixture of plastic and rubber.

5. The barbecue cleaning kit of claim 1, wherein said material of said first handle is hard.

6. The barbecue cleaning kit of claim 1, wherein said material of said second handle is hard.

7. The barbecue cleaning kit of claim 1, wherein said blade is made from a material selected from a group of aluminium, iron or an alloy.

8. The barbecue cleaning kit of claim 1, wherein said disposable bag is made of plastic.

9. A barbecue cleaning kit for removing soot and grease from a barbecue apparatus, wherein said barbecue cleaning kit comprises:
a barbecue scraper that is adapted to scrape said soot and grease, wherein said barbecue scraper comprises:
a first handle that is adapted to allow a user to hold said barbecue scraper,
wherein said first handle is made from plastic, rubber or mixture of plastic and rubber;
a thumb stop that is adapted to allow said user to maintain a grip to hold said barbecue scraper; and
a blade that is adapted to scrape said soot and grease, wherein said blade is made from aluminium, iron or an alloy;
a barbecue scoop that is adapted to collect said soot and grease wherein said barbecue scoop comprises:
a second handle that is adapted to allow said user to hold said barbecue scoop, wherein said second handle is made from plastic, rubber or mixture; and
a scoop pan that is adapted to collect said soot and grease;
a plastic disposable bag that is adapted to collect said soot and grease, wherein said plastic disposable bag comprises;
a rough edge that is adapted to scrape said soot and grease off said barbecue scraper and said barbecue scoop.

10. The barbecue cleaning kit of claim 9, wherein said barbecue apparatus is a gas barbecue apparatus or a charcoal barbecue apparatus.

11. The barbecue cleaning kit of claim 8, wherein said material of said first handle is hard.

12. The barbecue cleaning kit of claim 8, wherein said material of said second handle is hard.
